(19) United States
(12) Patent Application Publication
(10) Pub. No.: US 2011/0246951 A1
(43) Pub. Date: Oct. 6, 2011

(54) PORTABLE DEVICE AND UNLOCKING METHOD THEREOF

(75) Inventor: WEI-LIANG CHEN, Tu-Cheng (TW)

(73) Assignee: HON HAI PRECISION INDUSTRY CO., LTD., Tu-Cheng (TW)

(21) Appl. No.: 12/832,070

(22) Filed: Jul. 8, 2010

(30) Foreign Application Priority Data
Mar. 30, 2010 (CN) 201010136538.7

(51) Int. Cl. G06F 3/01

(52) U.S. Cl. 715/863

(57) ABSTRACT

A portable device and an unlocking method stores information groups, each information group including one primary key and at least one subordinate key. The portable device obtains the primary key, at least one subordinate key in one information group, and at least one subordinate key in another information group, and displays as an unlocking image. The portable device further detects user selection, and determine whether the user selection are the primary key and at least one subordinate key in the same information group. The portable device further switches from a lock state to an unlock state, when the user selection are the primary key and at least one subordinate key in the same information group.

### BACKGROUND

1. Technical Field

Embodiments of the present disclosure relate to electronic devices, and particularly to a portable device and an unlocking method of the portable device.

2. Description of Related Art

Most portable devices may have a lock function, to avoid misoperations on keyboards or touch-sensitive displays of the portable devices by accident. Nowadays, traditional unlocking methods are to input a predefined symbol, such as *, or via gestures performed on the touch-sensitive display, such as the APPLE IPHONE. However, the traditional unlocking methods just avoid the misoperations, without any security function.

Therefore, an unaddressed need exists in the portable device to avoid overcome the aforementioned problems.

### BRIEF DESCRIPTION OF THE DRAWINGS

FIG. 1 is a block diagram of one exemplary embodiment of a portable device of the present disclosure;

FIG. 2 is a schematic diagram of one exemplary embodiment of a storage system in the portable device of the present disclosure;

FIG. 3 is a schematic diagram of one exemplary embodiment of the portable device to display unlocking images of the present disclosure;

FIG. 4 is a schematic diagram of user selections performed on the unlocking images of the present disclosure; and

FIG. 5 is a flowchart of one exemplary embodiment of an unlocking method of the present disclosure.

### DETAILED DESCRIPTION

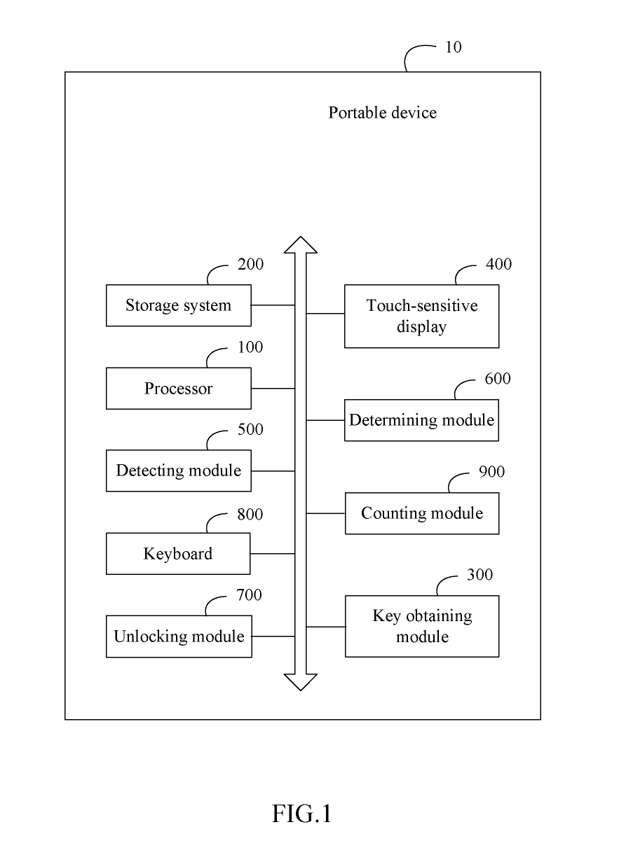

Referring to FIG. 1, a block diagram of one exemplary embodiment of a portable device 10 is shown. The portable device 10 may be telephones, personal digital assistant (PDA), or palm computers, for example.

The portable device 10 may be locked or unlocked. In one embodiment, the term “lock” is defined as a state of when the portable device 10 is powered on, but only responds to a limited number of input instructions, including responding to operating gestures to unlock the portable device 10, and active callings. The term “unlock” is defined as a state of when the portable device 10 is powered on, and may respond to all input instructions.

The portable device 10 comprises a storage system 200, a key obtaining module 300, a touch-sensitive display 400, a detecting module 500, a determining module 600, an unlocking module 700, a keyboard 800, a counting module 900, and a processor 100.

One or more computerized codes of the programs as functional modules 300, 500, 600, 700 and 900 of the portable device 10 may be stored in the storage system 200 and executed by the processor 100. In one embodiment, the storage system 200 may include hard disk drives, flash memories, RAM, ROM, caches, or external storage mediums.

The storage system 200 further stores information groups. In one embodiment, the term “information group” is defined as a row of information stored in a two-dimensional table, as in a database. Each information group comprises one primary key 211 and at least one subordinate key 212. It is known, the primary key 211 and the subordinate key 212 in a same information group are related, the primary key 211 and the subordinate key 212 in different information groups are unrelated.

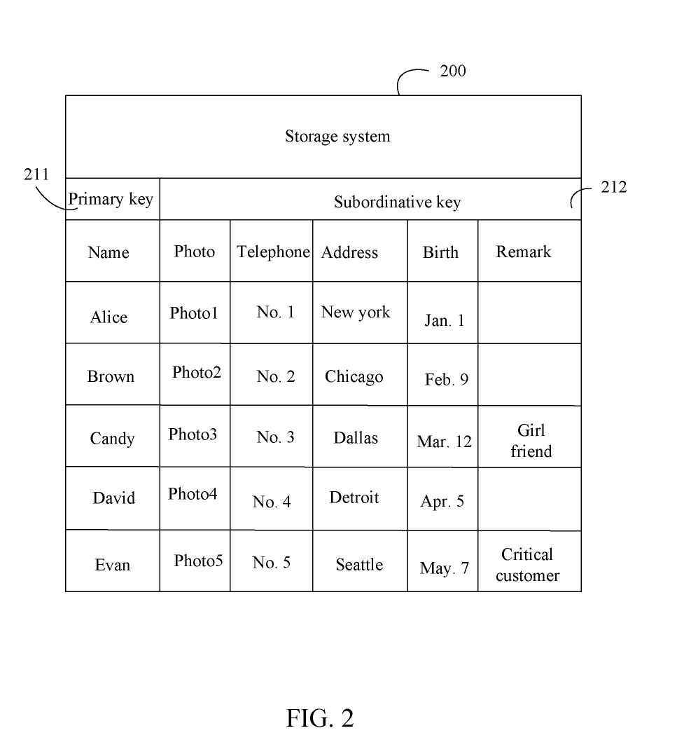

In one embodiment, the storage system 200 may include a telephone book. Referring to FIG. 2, the primary key 211 may be a name, and the at least one subordinate key 212 may be a photo, a telephone number, an address, a birthday, or a remark.

In other embodiments, the storage system 200 may store other information groups, such as a memo. At this condition, the primary key 211 may be a meeting date, and the at least one subordinate key may be a topic, a place, a telephone member, or a remark.

The detecting module 500 detects whether operating gestures are performed on the portable device 10. The term “operating gesture” is defined as a touch on the touch-sensitive display 400. The operating gestures, depending on the embodiment, may be from a finger or a stylus. In other embodiment, the touch performed on other inputs part of the portable device 10, such as the keyboard 800, are also defined as the operating gesture.

After detecting module 500 detects the operating gestures, the key obtaining module 300 obtains the primary key 211, at least one subordinate key 212 in one information group, and at least one subordinate key 212 in another information group from the storage system 200. In one embodiment, the key obtaining module 300 obtains at least one subordinate key 212 in the same information group, and at least one subordinate key 212 in a different information group randomly, and the primary key 211 may be predefined or obtained randomly.

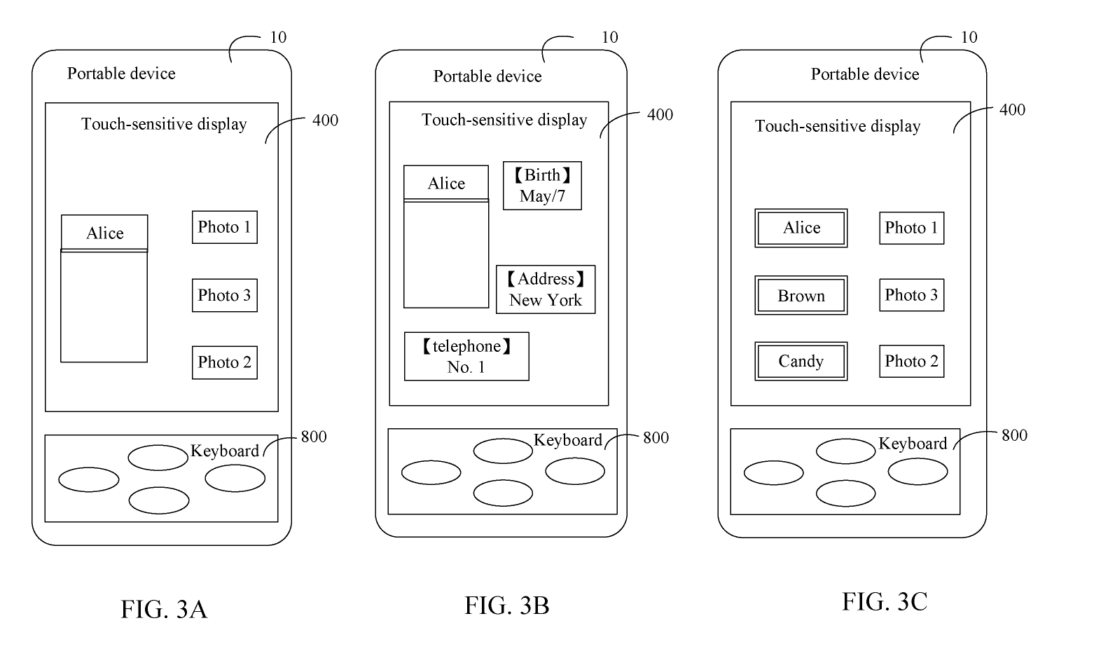

In one embodiment, the key obtaining module 300 further obtains a plurality of subordinate keys 212 in the different information groups. Referring to FIG. 3A, the key obtaining module 300 obtains the primary key 211, such as Alice, at least one subordinate key 212 in the same information group, such as Photo 1, and at least one subordinate key 212 in the different information groups, such as Photo 2 and Photo 3.

In another embodiment, the key obtaining module 300 further obtains a plurality of subordinate keys 212 in the same information group. Referring to FIG. 3B, the key obtaining module 300 obtains the primary key 211, such as Alice, at least one subordinate key 212 in the same information group, such as address New York and telephone No. 1, and at least one subordinate key 212 in the different information group, such as birthday May 7.

In another embodiment, the key obtaining module 300 further obtains a plurality of primary keys 211 and subordinate keys 212 in the corresponding information group. Referring to FIG. 3C, the key obtaining module 300 obtains the primary key 211, such as Alice, Brown, and Candy, at least one subordinate key 212 in the corresponding information group at least photo 1 of Alice, photo 2 of Brown, and photo 3 of Candy.

The touch-sensitive display 400 displays the obtained primary key 211 and the subordinate keys 212 as an unlocking image, for being chosen by a user, referring to FIG. 3A-FIG. 3B. The term “unlocking image” is defined as an image or images that may be displayed on the touch-sensitive display 400 for unlocking the portable device 10 with an unlocking rule. The location of the unlocking image on the touch-sensitive display 400 may be changed randomly each time.

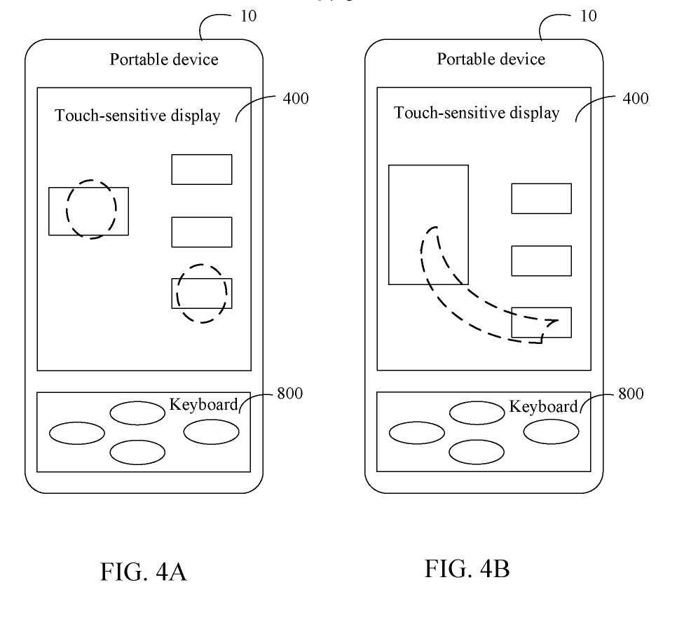

The detecting module 500 detects the operating gestures performed on the unlocking image as user selections. In one embodiment, the operating gestures on the unlocking images include clicking shown in FIG. 4A and moving shown in FIG. 4B. In one embodiment, the operating gestures may be performed on the touch-sensitive display 400, or just besides the touch-sensitive display 400. That is, the operating gestures may be performed directly on the touch-sensitive display 400 or apart a certain distance from the touch-sensitive display 400.

The determining module 500 determines whether the user selections are related to the primary key 211 and at least one subordinate key 212 in the same information group.

If the user selection are not the primary key 211 and at least one subordinate key 212 in the same information group, that is, the user selection includes any subordinate key 212 in the different information group, the determining module 500 further informs the counting module 900 to start calculate.

The counting module 900 calculates error times, and informs the unlocking module 700 to lock forcibly if the error times exceeds a predefined threshold. In one embodiment, the term “error time” is defined as the times of the user selection including the subordinate key 212 in the different information groups. The term “lock forcibly” is defined as the portable device 10 further stops responding to the operating gestures on the touch-sensitive display 400. In one embodiment, the lock forcibly may last between 5 seconds to 30 seconds.

If the user selections are related to the primary key 211 and at least one subordinate key 212 in the same information group, the unlocking module 700 unlocks the portable device 10. The unlocking module 700 further locks the portable device 10 when the portable device 10 is idle.

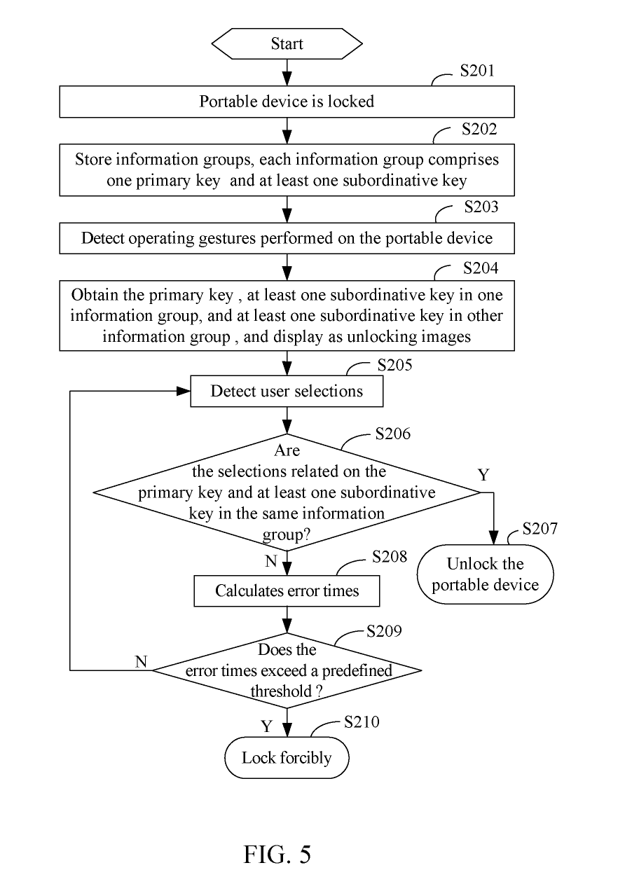

Referring to FIG. 5, one exemplary embodiment of an unlocking method of the present disclosure is shown. In one embodiment, the unlocking method is executed by the portable device 10 in FIG. 1.

In block S201, the portable device 10 is locked. In one embodiment, the term “lock” is defined as a state of when the portable device 10 is powered on, but only responds to a limited number of input instructions, including responding to operating gestures to unlock the portable device 10, and active callings.

In block S202, the storage system 200 stores information groups. In one embodiment, the term “information group” is defined as a row of information stored in a two-dimensional table, as in a database. Each information group includes one primary key 211 and at least one subordinate key 212. It is known, the primary key 211 and the subordinate key 212 in a same information group are related, the primary key 211 and the subordinate key 212 in different information groups are unrelated.

In one embodiment, the storage system 200 may include a telephone book, referring to FIG. 2, the primary key 211 may be a name, and the at least one subordinate key 212 may be a photo, a telephone number, an address, a birthday, or a remark. In other embodiments, the storage system 200 may store other kinds of information group, such as a memo, at this condition the primary key 211 may be a date, and the at least one subordinate key 212 may be a topic, a place, a telephone members, or a remark.

In block S203, the detecting module 500 detects operating gestures performed on the portable device 10, and informs the key obtaining module 300. The term “operating gesture” is defined as a touch on the touch-sensitive display 400. The operating gestures, depending on the embodiment, may be from a finger or a stylus. In other embodiment, the touch performed on other inputs part of the portable device 10, such as the keyboard 800, are also defined as the operating gesture.

In block S204, the key obtaining module 300 obtains the primary key 211, at least one subordinate key 212 in one information group, and at least one subordinate key 212 in another information group from the storage system 200, and displays the obtained primary key 211 and the subordinate keys 212 as an unlocking image. The term “unlocking image” is defined as an image or images that may be displayed on the touch-sensitive display 400 for unlocking the portable device 10 with an unlocking rule.

Referring to FIG. 3A-FIG. 3C, they are exemplary embodiment of the unlocking images displayed on the touch-sensitive display 400. In one embodiment, the key obtaining module 300 obtains at least one subordinate key 212 in the same information group, and at least one subordinate key 212 in the different information group randomly, and the primary key 211 may be predefined or obtained randomly.

In block S205, the detecting module 500 detect operating gestures performed on the touch-sensitive display 400 as user selections. In one embodiment, the operating gestures on the unlocking images include clicking shown in FIG. 4A and moving shown in FIG. 4B. The operating gestures may be performed on the touch-sensitive display 400, or just besides the touch-sensitive display 400. That is, the operating gestures may be performed directly on the touch-sensitive display 400 or apart a certain distance from the touch-sensitive display 400.

In block S206, the determining module 600 determines whether the user selections are the primary key 211 and at least one subordinate key 212 in the same information group. The flow goes to S207, if the user selection are the primary key 211 and at least one subordinate key 212 in the same information group. The flow goes to S208, if the choice are not the primary key 211 and at least one subordinate key 212 in the same information group, that is, the user selection includes any subordinate key 212 in the different information group.

In block S207, the unlocking module 700 unlocks the portable device 10.

In block S208, the counting module 900 calculates error times. In one embodiment, the term “error times” is defined as the times of the user selection including the subordinate key 212 in the different information group.

In block S209, the counting module 900 determines whether the error times exceed a predefined threshold. The flow goes to S205, if the error times within the predefined threshold. The flow goes to S210, if the error times exceed the predefined threshold.

In block S210, the determining module 600 keeps the portable device locked forcibly. The term “lock forcibly” is defined as the portable device 10 further stops responding to operating gestures on the touch-sensitive display 400. In one embodiment, the lock forcibly may last between 5 seconds to 30 seconds.

The description of the present disclosure has been presented for purposes of illustration and description, and is not intended to be exhaustive or limited to the disclosure in the form disclosed. Many modifications and variations will be apparent to those of ordinary skill in the art. Various embodiments were chosen and described in order to best explain the principles of the disclosure, the practical application, and to enable others of ordinary skill in the art to understand the disclosure for various embodiments with various modifications as are suited to the particular use contemplated.

What is claimed is:

1. A portable device, comprising:
a processor;
a storage system storing information groups;
a touch-sensitive display; and
one or more programs, wherein each information group comprises one primary key and at least one subordinate key, the primary key and the subordinate key in a same information group being related, the primary key and the subordinate key in different information groups being unrelated, the one or more programs being further stored in the storage system and executed by the processor and comprise:
a key obtaining module to obtain one primary key and at least one subordinate key in the same information group, and at least one subordinate key in the different information group from the storage system, and display the obtained primary key and subordinate keys on the touch-sensitive display;
a detecting module to detect operating gestures performed on the touch-sensitive display as user selections;
a determining module to determine whether the user selections are related to the primary key and with the at least subordinate keys in the same one information group; and
an unlocking module to unlock the portable device upon the condition that the user selections related to the one primary key and the at least subordinate key in the same information group.

2. The portable device as claimed in claim 1, wherein the unlocking module keeps the portable device locked upon the condition that the user selections related to the at least subordinate key in the different information group with the one primary key.

3. The portable device as claimed in claim 2, wherein the detecting module is further to detect operating gestures performed on the portable device, and the key obtaining module starts the obtaining upon the condition the detecting module detects the operating gestures performed on the portable device when the portable device is locked.

4. The portable device as claimed in claim 3, wherein the information groups are related to a phonebook, the primary key is a name, and the at least subordinate key is a selected one from photo, a telephone number, an address, a birthday, and a remark.

5. The portable device as claimed in claim 3, wherein information groups are on a memo, the primary key is a date, and the subordinate keys are a topic, a place, a member, and a remark.

6. The portable device as claimed in claim 5, wherein the obtaining of the primary key, the subordinate keys in the same information group of the primary key, and the subordinate keys in the different information groups of the key obtaining module is randomly.

7. The portable device as claimed in claim 5, wherein the key obtaining module is further to predefine the primary key and randomly obtain the subordinate keys in the same information group and the subordinate keys in the different information group.

8. An unlocking method to unlock a locked portable device, comprising:
storing information groups, each information group comprising one primary key and at least one subordinate key, wherein the primary key and the subordinate key in a same information group being related, the primary key and the subordinate key in different information groups being unrelated;
detecting operating gestures performed on the portable device;
obtaining the primary key, at least one subordinate key in one information group, and at least one subordinate key in another information group, and displaying the obtained primary key and subordinate keys on the touch-sensitive display as an unlocking image;
detecting the operating gestures on the unlocking image as user selection;
determining whether the user selections are related to the primary key and at least one subordinate key in the same information group; and
switching from a lock state of the portable device to an unlock state if the user selections are the primary key and at least one subordinate key in the same information group.

9. The unlocking method as claimed in claim 8, further comprising: maintaining the lock state if the user selections comprise the subordinate key in the different information groups.

10. The unlocking method as claimed in claim 8, wherein the primary key is a name, and the subordinate keys comprise a photo, a telephone number, an address, a birthday, and a remark.

11. The unlocking method as claimed in claim 8, wherein the primary key is a date, and the subordinate keys comprise a topic, a place, members, and a remark.

12. The unlocking method as claimed in claim 8, wherein the primary key, at least one subordinate key in the same information group, and at least one subordinate key in a different information group are obtained randomly.

13. The unlocking method as claimed in claim 8, wherein the primary key is predefined, at least one subordinate key in the same information group, and at least one subordinate key in a different information group are obtained randomly.
